(19) United States
(12) Patent Application Publication
(10) Pub. No.: US 2024/0132703 A1
(43) Pub. Date: Apr. 25, 2024

(54) RUBBER COMPOSITION AND PNEUMATIC TIRE USING THE SAME

(71) Applicant: Toyo Tire Corporation, Itami-shi (JP)

(72) Inventors: Souichiro Miura, Itami-shi (JP); Norio Minouchi, Itami-shi (JP)

(73) Assignee: Toyo Tire Corporation, Itami-shi (JP)

(21) Appl. No.: 18/227,507

(22) Filed: Jul. 28, 2023

(30) Foreign Application Priority Data
Aug. 26, 2022 (JP) 2022-134834

(51) Int. Cl. C08K 13/02; B60C 1/00; B60C 13/00; C08L 7/00

(52) U.S. Cl. CPC C08K 13/02; B60C 1/0025; B60C 13/002; C08L 7/00; C08K 5/18; C08K 2201/014

(57) ABSTRACT

Provided are a rubber composition, which is capable of providing excellent ozone resistance while suppressing discoloration, and a pneumatic tire using the same.

The rubber composition includes a diene-based rubber, a filler, a phenylenediamine represented by the following formula (1) (wherein R₁ and R₂ are each an alkyl group or aryl group with 7 or more carbon atoms, provided that at least one of R₁ and R₂ is an alkyl group with 7 or more carbon atoms), and a quinoline-based antioxidant, and is free of N-phenyl-N′-isopropyl-p-phenylenediamine (IPPD) and N-phenyl-N′-(1,3-dimethylbutyl)-p-phenylenediamine (6PPD).

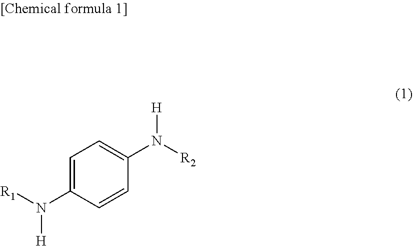

### BACKGROUND OF THE INVENTION

### 1. Field of the Invention

The present invention relates to a rubber composition and also to a pneumatic tire using the same.

### 2. Description of Related Art

In rubber compositions for use in tires, from the viewpoint of ozone resistance, N-phenyl-N′-isopropyl-p-phenylenediamine (IPPD) or N-phenyl-N′-(1,3-dimethylbutyl)-p-phenylenediamine (6PPD) is generally used as an antioxidant. However, because these compounds are highly mobile, there has been a risk that they may be transferred to the rubber surface, causing discoloration on the tire surface.

### SUMMARY OF THE INVENTION

In view of the above points, an object of an aspect of the invention is to provide a rubber composition capable of providing excellent ozone resistance while suppressing discoloration, and also a pneumatic tire using the same.

Incidentally, in JP2013-221052A, JP2013-95837A, JP2009-24134A, JPH10-324779A, and JP2021-91163A, there is no description of examples where a phenylenediamine having an alkyl group with 7 or more carbon atoms and a quinoline-based antioxidant are used together, and N-phenyl-N′-isopropyl-p-phenylenediamine (IPPD) and N-phenyl-N′-(1,3-dimethylbutyl)-p-phenylenediamine (6PPD) are not contained.

The invention encompasses the following embodiments.
[1] A rubber composition including a diene-based rubber, a filler, a phenylenediamine represented by the following formula (1), and a quinoline-based antioxidant, in which the rubber composition is free of N-phenyl-N′-isopropyl-p-phenylenediamine (IPPD) and N-phenyl-N′-(1,3-dimethylbutyl)-p-phenylenediamine (6PPD):

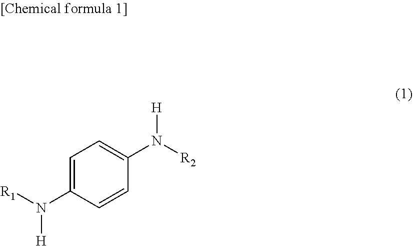

wherein R₁ and R₂ are each an alkyl group or aryl group with 7 or more carbon atoms, provided that at least one of R₁ and R₂ is an alkyl group with 7 or more carbon atoms.
[2] The rubber composition according to [1], in which the rubber composition includes carbon black and is free of silica, or if silica is present, the content thereof is less than 2 parts by mass per 100 parts by mass of the diene-based rubber.
[3] A pneumatic tire including the rubber composition according to [1] or [2] used in a sidewall thereof.
[4] The pneumatic tire according to [3], including a laminate formed by attaching a cover rubber to a surface of the sidewall.

According to a rubber composition of an aspect of the invention, excellent ozone resistance can be obtained while suppressing discoloration.

### BRIEF DESCRIPTION OF THE DRAWINGS

FIG. 1 is a half cross-sectional view of a pneumatic tire according to one embodiment of the invention; and

FIGS. 2A-2C are an enlarged cross-sectional view of a main part showing the production process of the above pneumatic tire.

### DESCRIPTION OF EMBODIMENTS

Hereinafter, matters relevant to the practice of the invention will be described in detail.

A rubber composition according to this embodiment includes a diene-based rubber, a filler, a phenylenediamine represented by the following formula (1), and a quinoline-based antioxidant, and is free of N-phenyl-N′-isopropyl-p-phenylenediamine (IPPD) and N-phenyl-N′-(1,3-dimethylbutyl)-p-phenylenediamine (6PPD).

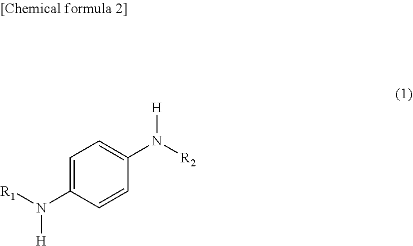

In formula (1), R₁ and R₂ are each an alkyl group or aryl group with 7 or more carbon atoms, provided that at least one of R₁ and R₂ is an alkyl group with 7 or more carbon atoms.

As diene-based rubbers, for example, natural rubbers (NR), isoprene rubbers (IR), butadiene rubbers (BR), styrene butadiene rubbers (SBR), nitrile rubbers (NBR), chloroprene rubbers (CR), butyl rubbers (IIR), styrene-isoprene copolymer rubbers, butadiene-isoprene copolymer rubbers, styrene-isoprene-butadiene copolymer rubbers, and the like can be mentioned. Among them, natural rubbers and butadiene rubbers are preferable, and it is more preferable to use a natural rubber and a butadiene rubber together. In addition, diene-based rubbers also include these rubbers as modified. As modified rubbers, for example, modified SBR and modified BR can be mentioned. A modified rubber can have a heteroatom-containing functional group. The functional group may be introduced at the terminal of the polymer chain or into the polymer chain, but is preferably introduced at the terminal. As functional groups, amino groups, alkoxyl groups, hydroxyl groups, carboxyl groups, epoxy groups, cyano groups, halogen groups, and the like can be mentioned. Among them, amino groups, alkoxyl groups, hydroxyl groups, and carboxyl groups are preferable. A modified rubber can have at least one of the illustrated functional groups. As amino groups, a primary amino group, a secondary amino group, a tertiary amino group, and the like can be mentioned. As alkoxyl groups, a methoxy group, an ethoxy group, a propoxy group, a butoxy group, and the like can be mentioned. The illustrated functional groups interact with silanol groups (Si—OH) of silica. Here, an interaction means chemical bonding or hydrogen bonding through a chemical reaction with silanol groups of silica, for example. The amount of modified rubber in 100 mass % of the diene-based rubber may be 10 mass % or more, 20 mass % or more, or 30 mass % or more, and may be 90 mass % or less, 80 mass % or less, or 70 mass % or less.

The rubber composition according to this embodiment contains a filler. Examples of fillers include carbon black and silica. As carbon black, any of known various species can be used. As silica, for example, wet silica such as wet-precipitated silica or wet-gelled silica may be used.

The filler content is not particularly limited, and is, per 100 parts by mass of the diene-based rubber, preferably 10 to 100 parts by mass, and more preferably 20 to 80 parts by mass. The carbon black content is, per 100 parts by mass of the diene-based rubber, preferably 10 to 80 parts by mass, and more preferably 10 to 70 parts by mass.

It is preferable that the rubber composition is free of silica, or if silica is present, the content thereof is less than 2 parts by mass per 100 parts by mass of the diene-based rubber.

The phenylenediamine used in this embodiment is represented by formula (1). R₁ and R₂ in formula (1) are each an alkyl group or aryl group with 7 or more carbon atoms, provided that at least one of R₁ and R₂ is an alkyl group with 7 or more carbon atoms. It is preferable that R₁ and R₂ are each an alkyl group with 7 to 20 carbon atoms or a phenyl group, provided that at least one of R₁ and R₂ is an alkyl group with 7 to 20 carbon atoms.

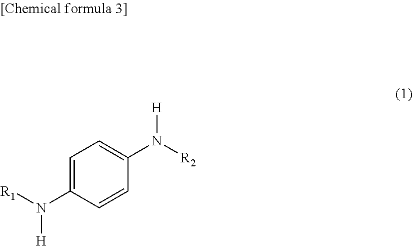

As such phenylenediamines, for example, N,N′-bis(1,4-dimethylpentyl)-p-phenylenediamine (77PD), N-phenyl-N′-(1-methylheptyl)-p-phenylenediamine (8PPD), N-phenyl-N′-(1,4-dimethylpentyl)-p-phenylenediamine (7PPD), and the like can be mentioned.

The phenylenediamine content is, per 100 parts by mass of the diene-based rubber, preferably 0.1 to 20 parts by mass, more preferably 0.5 to 15 parts by mass, still more 1 to 10 parts by mass, and particularly preferably 2 to 5 parts by mass.

As quinoline-based antioxidants, for example, 2,2,4-trimethyl-1,2-dihydroquinoline polymers (TMQ), poly(2,2,4-trimethyl-1,2-dihydroquinoline), 6-ethoxy-1,2-dihydro-2,2,4-trimethylquinoline (ETMQ), and the like can be mentioned.

The quinoline-based antioxidant content is, per 100 parts by mass of the diene-based rubber, preferably 0.1 to 20 parts by mass, more preferably 0.5 to 15 parts by mass, still more preferably 1 to 10 parts by mass, and particularly preferably 1 to 6 parts by mass.

The total antioxidant content (the total of the phenylenediamine and quinoline-based antioxidant described above) is, per 100 parts by mass of the diene-based rubber, preferably 1 to 20 parts by mass, more preferably 1 to 15 parts by mass, and still more preferably 1 to 10 parts by mass.

The content ratio between the phenylenediamine and the quinoline-based antioxidant is, on a mass basis, preferably 0.1 to 10, and more preferably 0.2 to 5.

In addition to the above components, the rubber composition according to this embodiment can incorporate various additives generally used in rubber compositions, such as zinc oxide, stearic acid, antioxidants, waxes, oils, resins, vulcanizing agents, and vulcanization accelerators.

Examples of oils include vegetable oils such as rapeseed oil and cottonseed oil, mineral oils such as paraffinic process oils, naphthenic process oils, and aromatic process oils, and plasticizers such as DOP and DBP. A suitable oil is selected in consideration of miscibility with the raw material rubber to be used. It is also possible to use two or more kinds of oils.

As resins, those having stickiness, that is, sticky resins are preferably used, and such a resin may be solid or liquid. As resins, for example, rosin-based resins, petroleum resins, coumarone-based resins, terpene-based resins, and the like can be mentioned. They may be used alone, and it is also possible to use two or more kinds together.

As rosin-based resins, for example, natural resin rosin and various rosin-modified resins using the same (e.g., rosin-modified maleic acid resin) can be mentioned.

As petroleum resins, aliphatic petroleum resins, aromatic petroleum resins, and aliphatic/aromatic copolymer petroleum resins can be mentioned. An aliphatic petroleum resin (also referred to as “C5-based petroleum resin”) is a resin obtained by cationically polymerizing an unsaturated monomer such as isoprene or cyclopentadiene, which is a petroleum fraction equivalent to 4 to 5 carbon atoms (C5 fraction), and may also be hydrogenated. An aromatic petroleum resin (also referred to as “C9-based petroleum resin”) is a resin obtained by cationically polymerizing a monomer such as vinyltoluene, an alkylstyrene, or indene, which is a petroleum fraction equivalent to 8 to 10 carbon atoms (C9 fraction), and may also be hydrogenated. An aliphatic/aromatic copolymer petroleum resin (also referred to as “C5/C9-based petroleum resin”) is a resin obtained by copolymerizing the C5 fraction and C9 fraction described above, and may also be hydrogenated.

A coumarone-based resin is a resin whose main component is coumarone, and, for example, coumarone resins, coumarone-indene resins, copolymer resins whose main components are coumarone, indene, and styrene, and the like can be mentioned.

As terpene-based resins, polyterpene, terpene-phenol resins, and the like can be mentioned.

The resin content is not particularly limited and may be, for example, per 100 parts by mass of the diene-based rubber, 1 to 30 parts by mass, 5 to 20 parts by mass, or 10 to 20 parts by mass.

A preferred example of the vulcanizing agents is sulfur. The vulcanizing agent content is not particularly limited, but is, per 100 parts by mass of the diene-based rubber, preferably 0.1 to 10 parts by mass, and more preferably 0.5 to 5 parts by mass. In addition, as the vulcanization accelerators, for example, sulfenamide-based, thiuram-based, thiazole-based, guanidine-based, and like various vulcanization accelerators can be mentioned. They can be used alone or as a combination of two or more kinds. The vulcanization accelerator content is not particularly limited, but is, per 100 parts by mass of the diene-based rubber, preferably 0.1 to 7 parts by mass, and more preferably 0.5 to 5 parts by mass.

The rubber composition according to this embodiment can be prepared by kneading in the usual manner using a commonly used mixer, such as a Banbury mixer, a kneader, or a roll. That is, for example, in the first mixing stage, additives excluding a vulcanizing agent and a vulcanization accelerator are added to the diene-based rubber and mixed, and then, in the final mixing stage, a vulcanizing agent and a vulcanization accelerator are added to the obtained mixture and mixed, whereby a rubber composition can be prepared.

The pneumatic tire of the invention can be obtained by the vulcanization molding of a tire using the above rubber composition. The conditions for such tire vulcanization are not particularly limited, and vulcanization is usually performed at 140 to 180° C. for 10 to 30 minutes.

In the invention, the entirety of the rubber portion of a tire may be formed from the rubber composition, but usually the rubber composition is partially used. That is, a rubber part made of the rubber composition is provided at least partially in the tread, sidewall, and bead. In that case, each of the tread, sidewall, and bead may be entirely or partially formed of the rubber part. In any case, it is preferable that the rubber part is provided on the tire surface side so as to be visible from the outside. Preferably, the sidewall is entirely or partially formed of the rubber part.

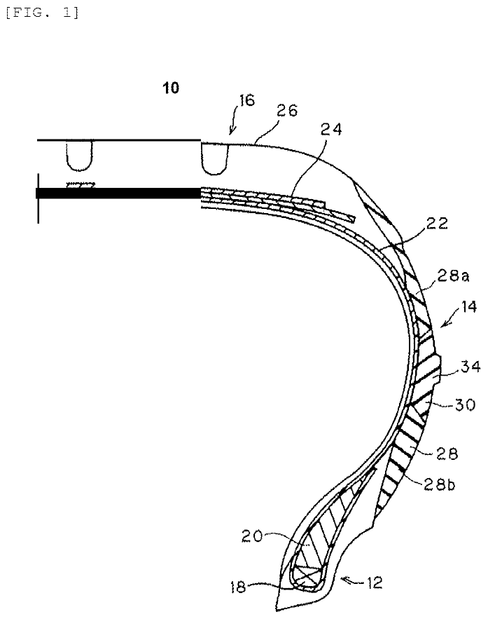

FIG. 1 is a half cross-sectional view of a pneumatic radial tire 10 according to one embodiment of the invention. This tire 10 is configured to include a pair of left and right beads 12, a pair of left and right sidewalls 14, and a tread 16 extending between the sidewalls 14. In the bead 12, an annular bead core 18 and, on the radially outer side thereof, a rubber bead filler 20 are disposed. Between the pair of left and right bead cores 18, there is provided a carcass layer 22 formed of many extended cords arranged perpendicularly to the tire circumferential direction, and both ends of the carcass layer 22 are latched by the respective bead cores 18. On the radially outer side of the carcass layer 22 in the tread 16, a belt layer 24 composed of inextensible cords is provided, and, on the tire radially outer side of the belt layer 24, a tread rubber 26 is provided. In addition, on the outer side of the carcass layer 22 in the sidewall 14, a sidewall rubber 28 is provided.

In the tire 10 having such a configuration, in this embodiment, a portion of the sidewall rubber 28 is formed as a color rubber 30. Specifically, the color rubber 30 makes the radially central portion of the sidewall rubber 28, and, on the upper and lower sides thereof, black sidewall rubbers 28a and 28b made of the above rubber composition are provided.

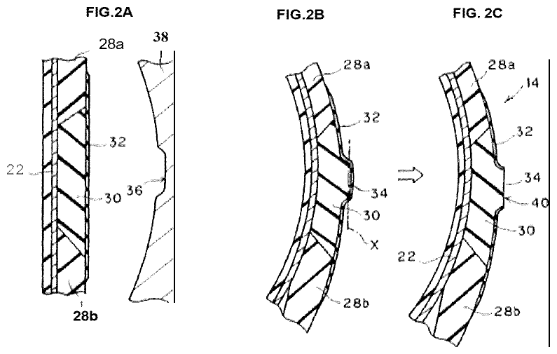

As enlarged and shown in FIG. 2C, a cover rubber layer 32 is provided over and around the color rubber 30 on the sidewall 14 surface. The cover rubber layer 32 is a black rubber layer of the same color as the normal sidewall rubbers 28a and 28b, and, as a result of partially covering the color rubber 30, display information 40, such as predetermined pictures, letters, symbols, and patterns, is externally indicated by the uncovered portion.

The structure shown in FIG. 2C can be formed as follows. That is, as shown in FIG. 2A, the sidewall rubbers 28a and 28b and the color rubber 30 between them are attached to the outer side of the carcass layer 22, and the cover rubber layer 32 is further attached to the outer side thereof to make a green tire. Then, the green tire is vulcanization-molded using a molding die 38 having a recess 36 so as to form a protrusion 34 extending in the circumferential direction on the surface of the color rubber 30. Then, after vulcanization molding, as shown in FIG. 2B, the cover rubber layer 32 on the tip surface of the protrusion 34 is shaved as indicated by the dashed-dotted line X, thereby exposing the predetermined position of the color rubber 30 as shown in FIG. 2C. As a result of formation in this manner, the predetermined display information 40 described above can be formed accurately and easily.

Incidentally, the cover rubber layer 32 is preferably composed of a rubber composition containing an ethylene propylene rubber (EPDM), a halogenated butyl rubber, or a natural rubber as a rubber component and carbon black as a filler. The rubber composition may contain an antioxidant such as a phenol-based antioxidant, but is preferably a non-staining rubber composition that does not contain a staining chemical such as an antioxidant so as not to stain the sidewall rubber 28 and the color rubber 30.

### REFERENCE SIGNS LIST

10: Pneumatic tire
14: Sidewall
28: Sidewall rubber
30: Color rubber
32: Cover rubber layer

### EXAMPLES

Hereinafter, examples of the invention will be shown, but the invention is not limited to these examples.

Using a lab mixer, following the formulations (parts by mass) shown in Tables 1 and 2, first, in the first mixing stage, ingredients excluding sulfur and a vulcanization accelerator were added to a diene-based rubber and kneaded (discharge temperature=160° C.). Next, in the final mixing stage, sulfur and a vulcanization accelerator were added to the obtained kneaded product and kneaded (discharge temperature=90° C.), thereby preparing a rubber composition. The details of the components in Tables 1 and 2 are as follows.
BR 1: “BR 150B” manufactured by Ube Industries, Ltd., cis content: 97%, glass transition temperature: −100° C.
BR 2: “Diene NF35R” manufactured by Asahi Kasei Corporation, cis content: 32%, glass transition temperature: −90° C.
NR: RSS #3
Carbon black: “SEAST 3” manufactured by Tokai Carbon Co., Ltd.
Zinc oxide: “Type 1 Zinc Oxide” manufactured by Mitsui Mining & Smelting Co., Ltd.
Stearic acid: “LUNAC S-20” manufactured by Kao Corporation
Wax: “OZOACE 0355” manufactured by Nippon Seiro Co., Ltd.
Process oil: “PROCESS OIL NC140” manufactured by ENEOS Corporation
Amine-based antioxidant 1: “NOCRAC 810-NA” manufactured by Ouchi Shinko Chemical Industrial Co., Ltd., N-phenyl-N′-isopropyl-p-phenylenediamine (IPPD)
Amine-based antioxidant 2: “NOCRAC 6C” manufactured by Ouchi Shinko Chemical Industrial Co., Ltd., N-phenyl-N′-(1,3-dimethylbutyl)-p-phenylenediamine (6PPD)
Amine-based antioxidant 3: “Vulkanox 4030” manufactured by LANXESS, N,N′-bis(1,4-dimethylpentyl)-p-phenylenediamine (77PD)
Amine-based antioxidant 4: “OZONONE 35” manufactured by Seiko Chemical Co., Ltd., N-phenyl-N′-(1-methylheptyl)-p-phenylenediamine (8PPD)
Amine-based antioxidant 5: “Santoflex 7PPD” manufactured by Eastman, N-phenyl-N′-(1,4-dimethylpentyl)-p-phenylenediamine (7PPD)
Quinoline-based antioxidant 1: “NOCRAC 224” manufactured by Ouchi Shinko Chemical Industrial Co., Ltd., 2,2,4-trimethyl-1,2-dihydroquinoline polymer (TMQ)
Quinoline-based antioxidant 2: “NOCRAC AW” manufactured by Ouchi Shinko Chemical Industrial Co., Ltd., 6-ethoxy-1,2-dihydro-2,2,4-trimethylquinoline (ETMQ)
Sulfur: “Powder Sulfur” manufactured by Tsurumi Chemical Industry Co., Ltd.
Vulcanization accelerator: “SOXINOL CZ” manufactured by Sumitomo Chemical Co., Ltd.

Each obtained rubber composition was vulcanized at 160° C. for 20 minutes to prepare a test piece having a predetermined shape, and ozone resistance and discoloration were evaluated. The evaluation methods are as follows.
Ozone Resistance: The test piece under the condition of 25% elongation was placed in an ozone weather meter device and left for 24 hours in an environment with an ozone concentration of 100 pphm and a temperature of 50° C. Subsequently, the state of crack generation was observed visually and under a 10× magnifying glass. The ozone resistance was evaluated on the following four-point scale.
4: No cracks generated
3: Cracks not visible to the naked eye but recognizable under a 10× magnifying glass generated
2: Cracks of 1 mm or less generated
1: Cracks exceeding 1 mm generated
Discoloration: Using a spectrophotometer “CR-200” manufactured by Konica Minolta, Inc., the hue of a sample after a 6-month outdoor exposure test was measured. Color change was calculated based on ΔE. The smaller the value of ΔE, the smaller the color change before and after outdoor exposure, and the better the appearance.
A: ΔE=3.0 or less
B: ΔE=3.0 or more and 6.0 or less
C: ΔE=6.0 or more and 9.0 or less
D: ΔE=9.0 or more

TABLE 1

| | Comp. | Comp. | Comp. | Comp. | Comp. | Comp. | Comp. | Comp. | Comp. | Comp. |
|---|---|---|---|---|---|---|---|---|---|---|
| | Ex. 1-1 | Ex. 1-2 | Ex. 1-3 | Ex. 1-4 | Ex. 1-5 | Ex. 1-6 | Ex. 1-7 | Ex. 1-8 | Ex. 1-9 | Ex. 1-10 |
| BR 1 | 30 | 30 | 30 | 30 | 30 | 30 | 30 | 30 | 30 | 30 |
| BR 2 | 30 | 30 | 30 | 30 | 30 | 30 | 30 | 30 | 30 | 30 |
| NR | 40 | 40 | 40 | 40 | 40 | 40 | 40 | 40 | 40 | 40 |
| Carbon black | 50 | 50 | 50 | 50 | 50 | 50 | 50 | 50 | 50 | 50 |
| Zinc oxide | 3 | 3 | 3 | 3 | 3 | 3 | 3 | 3 | 3 | 3 |
| Stearic acid | 3 | 2 | 3 | 2 | 3 | 3 | 3 | 3 | 3 | 3 |
| Wax | 2 | 2 | 2 | 2 | 2 | 2 | 2 | 2 | 2 | 2 |
| Process oil | 20 | 20 | 20 | 20 | 20 | 20 | 20 | 20 | 20 | 20 |
| Amine-based | 3 | — | — | — | — | — | — | — | — | — |
| antioxidant 1 | | | | | | | | | | |
| Amine-based | — | 3 | 2 | 3 | — | — | — | 2 | 2 | 2 |
| antioxidant 2 | | | | | | | | | | |
| Amine-based | — | — | — | — | 3 | — | — | 2 | — | — |
| antioxidant 3 | | | | | | | | | | |
| Amine-based | — | — | — | — | — | 3 | — | — | 2 | — |
| antioxidant 4 | | | | | | | | | | |
| Amine-based | — | — | — | — | — | — | 3 | — | — | 2 |
| antioxidant 5 | | | | | | | | | | |
| Quinoline- | 2 | 2 | 4 | — | — | — | — | 2 | 2 | 2 |
| based | | | | | | | | | | |
| antioxidant 1 | | | | | | | | | | |
| Quinoline- | — | — | — | 3 | — | — | — | — | — | — |
| based | | | | | | | | | | |
| antioxidant 2 | | | | | | | | | | |
| Sulfur | 2 | 2 | 2 | 2 | — | — | — | — | — | — |
| Vulcanization | 1 | 1 | 1 | 1 | — | — | — | — | — | — |
| accelerator | | | | | | | | | | |
| Ozone | 3 | 3 | 2 | 3 | 3 | 2 | 2 | 3 | 3 | 3 |
| resistance | | | | | | | | | | |
| Discoloration | D | D | C | D | C | D | D | C | D | D |

(Comp. Ex.: Comparative Example)

TABLE 2

| | | | | | | | | | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|---|---|---|---|---|
| | Ex. | Ex. | Ex. | Ex. | Ex. | Ex. | Ex | Ex. | Ex. | 1- | 1- | 1- | 1- | 1- | 1- | 1- | 1- | 1- | 1- | 1- | 1- |
| | 1-1 | 1-2 | 1-3 | 1-4 | 1-5 | 1-6 | 1-7 | 1-8 | 1-9 | 10 | 11 | 12 | 13 | 14 | 15 | 16 | 17 | 18 | 19 | 20 | 21 |
| BR 1 | 30 | 30 | 30 | 30 | 30 | 30 | 30 | 30 | 30 | 30 | 30 | 30 | 30 | 30 | 30 | 30 | 30 | 30 | 30 | 30 | 30 |
| BR 2 | 30 | 30 | 30 | 30 | 30 | 30 | 30 | 30 | 30 | 30 | 30 | 30 | 30 | 30 | 30 | 30 | 30 | 30 | 30 | 30 | 30 |
| NR | 40 | 40 | 40 | 40 | 40 | 40 | 40 | 40 | 40 | 40 | 40 | 40 | 40 | 40 | 40 | 40 | 40 | 40 | 40 | 40 | 40 |
| Carbon black | 50 | 50 | 50 | 50 | 50 | 50 | 50 | 50 | 50 | 50 | 50 | 50 | 50 | 50 | 50 | 50 | 50 | 50 | 50 | 50 | 50 |
| Zinc oxide | 3 | 3 | 3 | 3 | 3 | 3 | 3 | 3 | 3 | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 | 2 | 2 | 2 | 2 | 2 | 2 | 2 | 2 | 2 |
| Process oil | 20 | 20 | 20 | 20 | 20 | 20 | 20 | 20 | 20 | 20 | 20 | 20 | 20 | 20 | 20 | 20 | 20 | 20 | 20 | 20 | 20 |
| Amine-based antioxidant 1 | — | — | — | — | — | — | — | — | — | — | — | — | — | — | — | — | — | — | — | — | — |
| Amine-based antioxidant 2 | — | — | — | — | — | — | — | — | — | — | — | — | — | — | — | — | — | — | — | — | — |
| Amine-based antioxidant 3 | 2 | 3 | 3 | 4 | 2.5 | 4 | 4 | — | — | — | — | — | — | — | — | — | — | — | — | — | — |
| Amine-based antioxidant 4 | — | — | — | — | — | — | — | 2 | 3 | 3 | 4 | 2.5 | 4 | 4 | — | — | — | — | — | — | — |
| Amine-based antioxidant 5 | — | — | — | — | — | — | — | — | — | — | — | — | — | — | 2 | 3 | 3 | 4 | 2.5 | 4 | 4 |
| Quinoline-based | 2 | 3 | — | 2 | 5 | 5 | — | 2 | 3 | — | 2 | 5 | 5 | — | 2 | 3 | — | 2 | 5 | 5 | — |
| antioxidant 1 | | | | | | | | | | | | | | | | | | | | | |
| Quinoline-based | — | — | 2 | — | — | — | 4 | — | — | 3 | — | — | — | 5 | — | — | 3.5 | — | — | — | 5 |
| antioxidant 2 | | | | | | | | | | | | | | | | | | | | | |
| Sulfur | 2 | 2 | 2 | 2 | 2 | 2 | 2 | 2 | 2 | 2 | 2 | 2 | 2 | 2 | 2 | 2 | 2 | 2 | 2 | 2 | 2 |
| Vulcanization accelerator | 1 | 1 | 1 | 1 | 1 | 1 | 1 | 1 | 1 | 1 | 1 | 1 | 1 | 1 | 1 | 1 | 1 | 1 | 1 | 1 | 1 |
| Ozone resistance | 3 | 3 | 3 | 3 | 3 | 3 | 3 | 3 | 3 | 3 | 3 | 3 | 3 | 3 | 3 | 3 | 3 | 3 | 3 | 3 | 3 |
| Discoloration | A | B | B | B | A | B | B | A | B | B | B | A | B | B | A | B | B | B | B | B | B |

(Ex.: Example)

The results are as shown in Tables 1 and 2. In Comparative Examples 1-1 to 1-4, which are examples where a phenylenediamine having an alkyl group with 6 or less carbon atoms and a quinoline-based antioxidant were used together, discoloration occurred.

In Comparative Examples 1-5 to 1-7, which are examples where a predetermined phenylenediamine was used alone, discoloration occurred.

In Comparative Examples 1-8 to 1-10, which are examples where a phenylenediamine having an alkyl group with 6 or less carbon atoms, a predetermined phenylenediamine, and a quinoline-based antioxidant were used together, discoloration occurred.

Meanwhile, in the examples where a predetermined phenylenediamine and a quinoline-based antioxidant were used together, excellent ozone resistance was obtained while suppressing discoloration.

In addition, using the rubber compositions of Comparative Example 1-5, Example 1-2, Example 1-10, and Example 1-19 in the sidewall, and also using a rubber composition prepared following the formulations (parts by mass) shown in Table 4 as the cover rubber, a tire having a tire size of 235/70R16 106Q was made, and the ozone resistance and discoloration of the tire were evaluated. The method for evaluating the ozone resistance of a tire is as follows. The method for evaluating the discoloration of a tire was the same as described above.

The details of the components in Table 4 are as follows.
EPDM: “ESPRENE 532” manufactured by Sumitomo Chemical Co., Ltd.
Chlorobutyl: “CHLOROBUTYL 1066” manufactured by JSR Corporation
NR: RSS #3
Carbon black: “SEAST SO” manufactured by Tokai Carbon Co., Ltd.
Zinc oxide: “Type 1 Zinc Oxide” manufactured by Mitsui Mining & Smelting Co., Ltd.
Stearic acid: “LUNAC S-20” manufactured by Kao Corporation
Wax: “OZOACE 0355” manufactured by Nippon Seiro Co., Ltd.
Antioxidant: “NOCRAC SP” manufactured by Seiko Chemical Co., Ltd.
Sulfur: “Powder Sulfur” manufactured by Tsurumi Chemical Industry Co., Ltd.
Vulcanization accelerator: “NOCCELER DM” manufactured by Ouchi Shinko Chemical Industrial Co., Ltd.
Ozone Resistance of Tire: The tire was mounted on a passenger car, and the conditions of the sidewall rubber surface after driving 50,000 km were evaluated in accordance with the JIS K6259 standard. Subsequently, the state of crack generation was observed visually and under a 10× magnifying glass, and the ozone resistance was evaluated on the following four-point scale.
4: No cracks generated
3: Cracks not visible to the naked eye but recognizable under a 10× magnifying glass generated
2: Cracks of 1 mm or less generated
1: Cracks exceeding 1 mm generated

TABLE 3

| | Comp. | Ex. | Ex. | Ex. |
|---|---|---|---|---|
| | Ex. 1-5 | 1-2 | 1-10 | 1-19 |
| BR 1 | 30 | 30 | 30 | 30 |
| BR 2 | 30 | 30 | 30 | 30 |
| NR | 40 | 40 | 40 | 40 |
| Carbon black | 50 | 50 | 50 | 50 |
| Zinc oxide | 3 | 3 | 3 | 3 |
| Stearic acid | 3 | 2 | 2 | 2 |
| Wax | 2 | 2 | 2 | 2 |
| Process oil | 20 | 20 | 20 | 20 |
| Amine-based antioxidant 1 | — | — | — | — |
| Amine-based antioxidant 2 | — | — | — | — |
| Amine-based antioxidant 3 | 3 | 3 | — | — |
| Amine-based antioxidant 4 | — | — | 3 | — |
| Amine-based antioxidant 5 | — | — | — | 2.5 |
| Quinoline-based antioxidant 1 | — | 3 | — | 5 |
| Quinoline-based antioxidant 2 | — | — | 3 | — |
| Sulfur | 2 | 2 | 2 | 2 |
| Vulcanization accelerator | 1 | 1 | 1 | 1 |
| Ozone resistance of tire | 3 | 3 | 3 | 3 |
| Discoloration of tire | B | A | A | A |

(Comp. Ex.: Comparative Example, Ex.: Example)

TABLE 4

| | |
|---|---|
| EPDM | 10 |
| Chlorobutyl | 30 |
| NR | 60 |
| Carbon black | 50 |
| Zinc oxide | 3 |
| Stearic acid | 3 |
| Wax | 2 |
| Phenolic antioxidant | 3 |
| Sulfur | 1 |
| Vulcanization accelerator | 1 |

The results are as shown in Table 3. In the tires of Example 1-2, Example 1-10, and Example 1-19, as compared to Comparative Example 1-5, excellent ozone resistance was obtained while suppressing discoloration.

The rubber composition of the invention can be used as a rubber composition for various tires for passenger cars, light trucks, buses, and the like.

1. A rubber composition comprising:
a diene-based rubber;
a filler;
a phenylenediamine represented by the following formula (1); and
a quinoline-based antioxidant, wherein
the rubber composition is free of N-phenyl-N′-isopropyl-p-phenylenediamine (IPPD) and N-phenyl-N′-(1,3-dimethylbutyl)-p-phenylenediamine (6PPD): 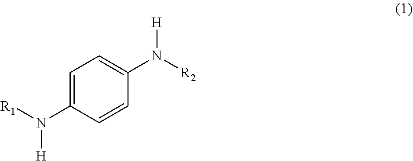
wherein R₁ and R₂ are each an alkyl group or aryl group with 7 or more carbon atoms, provided that at least one of R₁ and R₂ is an alkyl group with 7 or more carbon atoms.

2. The rubber composition according to claim 1, wherein the rubber composition comprises carbon black and is free of silica, or if silica is present, the content thereof is less than 2 parts by mass per 100 parts by mass of the diene-based rubber.

3. A pneumatic tire comprising the rubber composition according to claim 1 used in a sidewall thereof.

4. A pneumatic tire comprising the rubber composition according to claim 2 used in a sidewall thereof.

5. The pneumatic tire according to claim 3, comprising a laminate formed by attaching a cover rubber to a surface of the sidewall.

6. The pneumatic tire according to claim 4, comprising a laminate formed by attaching a cover rubber to a surface of the sidewall.

7. A rubber composition comprising:
a diene-based rubber;
a filler;
a phenylenediamine represented by the following formula (1); and
a quinoline-based antioxidant, wherein
the rubber composition is free of N-phenyl-N′-isopropyl-p-phenylenediamine (IPPD) and N-phenyl-N′-(1,3-dimethylbutyl)-p-phenylenediamine (6PPD): 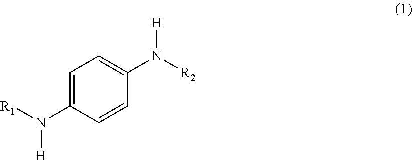
wherein R₁ and R₂ are each an alkyl group with 7 to 20 carbon atoms or a phenyl group, provided that at least one of R₁ and R₂ is an alkyl group with 7 to 20 carbon atoms.

8. The rubber composition according to claim 7, wherein the rubber composition comprises carbon black and is free of silica, or if silica is present, the content thereof is less than 2 parts by mass per 100 parts by mass of the diene-based rubber.

9. A pneumatic tire comprising the rubber composition according to claim 7 used in a sidewall thereof.

10. A pneumatic tire comprising the rubber composition according to claim 8 used in a sidewall thereof.

11. The pneumatic tire according to claim 9, comprising a laminate formed by attaching a cover rubber to a surface of the sidewall.

12. The pneumatic tire according to claim 10, comprising a laminate formed by attaching a cover rubber to a surface of the sidewall.

13. A rubber composition comprising:
a diene-based rubber;
a filler;
at least one phenylenediamine selected from the group consisting of N,N′-bis(1,4-dimethylpentyl)-p-phenylenediamine (77PD), N-phenyl-N′-(1-methylheptyl)-p-phenylenediamine (8PPD), and N-phenyl-N′-(1,4-dimethylpentyl)-p-phenylenediamine (7PPD); and
a quinoline-based antioxidant, wherein
the rubber composition is free of N-phenyl-N′-isopropyl-p-phenylenediamine (IPPD) and N-phenyl-N′-(1,3-dimethylbutyl)-p-phenylenediamine (6PPD).

14. The rubber composition according to claim 13, wherein the rubber composition comprises carbon black and is free of silica, or if silica is present, the content thereof is less than 2 parts by mass per 100 parts by mass of the diene-based rubber.

15. A pneumatic tire comprising the rubber composition according to claim 13 used in a sidewall thereof.

16. A pneumatic tire comprising the rubber composition according to claim 14 used in a sidewall thereof.

17. The pneumatic tire according to claim 15, comprising a laminate formed by attaching a cover rubber to a surface of the sidewall.

18. The pneumatic tire according to claim 16, comprising a laminate formed by attaching a cover rubber to a surface of the sidewall.
